(19) United States
(12) Patent Application Publication
(10) Pub. No.: US 2006/0156329 A1
(43) Pub. Date: Jul. 13, 2006

(54) Loyalty program for television viewers and method and system for rewarding a television viewer

(75) Inventor: Norbert Treese, Leipzig (DE)

Correspondence Address: THE WEBB LAW FIRM, P.C., 700 KOPPERS BUILDING, 436 SEVENTH AVENUE, PITTSBURGH, PA, 15219, US

(73) Assignee: 21st Century Entertainment Group AG, Zug (DE)

(21) Appl. No.: 11/032,313

(22) Filed: Jan. 10, 2005

(51) Int. Cl. H04N 7/16; H04H 9/00; H04N 5/445; H04N 7/10; H04N 7/025; G06F 3/00; G06F 13/00

(52) U.S. Cl. 725/23; 725/9; 725/46; 725/34; 725/35

(57) ABSTRACT

Disclosed is a loyalty program for television viewers and a method and system for rewarding a television viewer. The method includes the steps of: assigning a value to a specified program or a time slot of a specified channel; receiving, at a central data system, data reflective of the specified program or specified time slot that the viewer watched or intends to watch; storing the assigned value in a viewer account; and interacting with the viewer. The interaction is based upon the stored assigned values, the data, viewing time and/or sums, averages or specified portions of this data.

### BACKGROUND OF THE INVENTION

1. Field of the Invention

The present invention relates generally to methods, systems and programs for engendering loyalty in various consumers and customers and, in particular, to a loyalty program for television stations and other media, as well as a method and system for rewarding a television viewer who watches various channels of television.

2. Description of Related Art

Presently, television is the most popular form of media entertainment and watched by millions of viewers across the world. As the various media outlets grow, the consumer or viewer now has many more options and channels to choose from on the television. In short, the viewer typically has hundreds of channels and choices, and it is difficult for a television station or channel to attract and maintain a multitude of viewers in such a competitive environment. Therefore, there remains a need for developing a relationship between the viewer and the channel (or television station), thereby increasing the viewing time, which increases the market share of the channel or television station.

Television stations and channels typically receive income for a vendor's or merchant's use of commercial airtime on the station. However, additional sources of income should be explored based upon sales revenue sharing, telephone proceeds and other similar consumer sources. Such additional sources of income would make the television station or channel more resistant to fluctuating commercial revenues and markets.

Presently, there is no existing program that engenders loyalty between a consumer or viewer and a channel or television station. Further, when multiple channels are offering multiple, yet similar, programming, the viewer now makes the choice strictly based upon personal preference. Accordingly, there is a need for producing some lasting and mutually beneficial relationship between a particular television viewer and a specific television channel. In addition, any information or data exchanged between the viewer and the channel also is mutually beneficial, in that the viewer can receive better targeted marketing to his or her needs or desires and the channel can better assess its viewing population and use such targeted advertising.

In general, there remains a need for providing a community of viewers and channels (or television stations), where there are emotional ties between the viewers and the channels. There is also a need for linking viewers to certain affiliated trade partners of the linked channel, such as affiliated vendors or merchants, which thereby provides additional ties between the viewers and channels and these trade partners.

### SUMMARY OF THE INVENTION

It is, therefore, an object of the present invention to provide a loyalty program for television viewers and a method and system for rewarding a television viewer that overcomes the deficiencies of the prior art. It is another object of the present invention to provide a loyalty program for television viewers and a method for rewarding television viewers that engenders loyalty between the viewer and the channel and/or affiliated trade partners. It is yet another object of the present invention to provide a loyalty program for television viewers and a method and system for rewarding the television viewer that provides tangible benefits to the viewer in the form of various offers. It is a still further object of the present invention to provide a loyalty program for television viewers and a method and system for rewarding television viewers that allows for the flow of information and data between the parties to the mutual benefit of both parties. It is yet another object of the present invention to provide a loyalty program for television viewers and a method and system for rewarding television viewers that provides additional income to the channel, television station and affiliated trade partners.

Accordingly, the present invention is directed to a loyalty program for television viewers. Specifically, the present invention is directed to a method for rewarding a television viewer who views a program over a channel of the television. This method includes the steps of: assigning a value to a specified program of a plurality of programs or a time slot of a specified channel of a plurality of channels; receiving, at a central data system, data reflective of the specified program or the specified time slot that the viewer watched or intends to watch; storing the assigned value of the specified program or the specified time slot, the data reflective of the specified program or the data reflective of the specified time slot in a viewer account; and interacting with the viewer. In particular, the interaction with the viewer is based upon: the stored assigned value of the specified program or specified time slot in the viewer account; the data reflective of the specified program; the data reflective of the specified time slot; the sum of all viewing time; the average viewing time of a viewer over a specified period; the sum of all stored assigned values in the viewer account; and/or a specified portion of a stored assigned value, the sum of all viewing time or the sum of all assigned values in the viewer account.

In one preferred and non-limiting embodiment of the present invention, the method further includes the step of offering to the viewer, by a central data system manager, a service, an item, a discount, a redemption, a coupon, a voucher, a non-cash benefit, an incentive, a ticket, an invitation, and/or an event. The offer is based upon the stored assigned value of the specified program or specified time slot in the viewer account; the data reflective of the specified program; the data reflective of the specified time slot; the sum of all viewing time; the average viewing time of a viewer over a specified period; the sum of all stored assigned values in a viewer account; a stored viewer status value; a viewer viewing rating; a viewer status rating; and/or the specified portion of any of these values or sums.

The present invention is further directed to a system for rewarding a television viewer who views at least one program over a channel of the television. The system includes means for assigning a value to a specified program of a plurality of programs or a time slot of a specified channel of a plurality of channels; means for receiving, at a central data system, data reflective of the specified program or the specified time slot that the viewer watched or intends to watch; means for storing the assigned value of the specified program or the specified time slot, the data reflective of the specified program or the data reflective of the specified time slot in a viewer account; and means for interacting with the viewer based upon various values, collected data, sums, averages or specified portions of these values and sums.

The present invention, both as to its construction and its method of operation, together with the additional objects and advantages thereof, will best be understood from the following description of exemplary embodiments when read in connection with the accompanying drawings.

### BRIEF DESCRIPTION OF THE DRAWINGS

FIG. 1 is a flow diagram of a method for rewarding a television viewer according to the present invention;

FIG. 2 is a schematic view of one preferred and non-limiting embodiment of a method and system for rewarding a television viewer according to the present invention; and

FIG. 3 is a front view of a television displaying a banner in a method and system for rewarding a television viewer according to the present invention.

### DETAILED DESCRIPTION OF THE PREFERRED EMBODIMENTS

It is to be understood that the invention may assume various alternative variations and step sequences, except where expressly specified to the contrary. It is also to be understood that the specific devices and processes illustrated in the attached drawings, and described in the following specification, are simply exemplary and presently preferred embodiments of the invention.

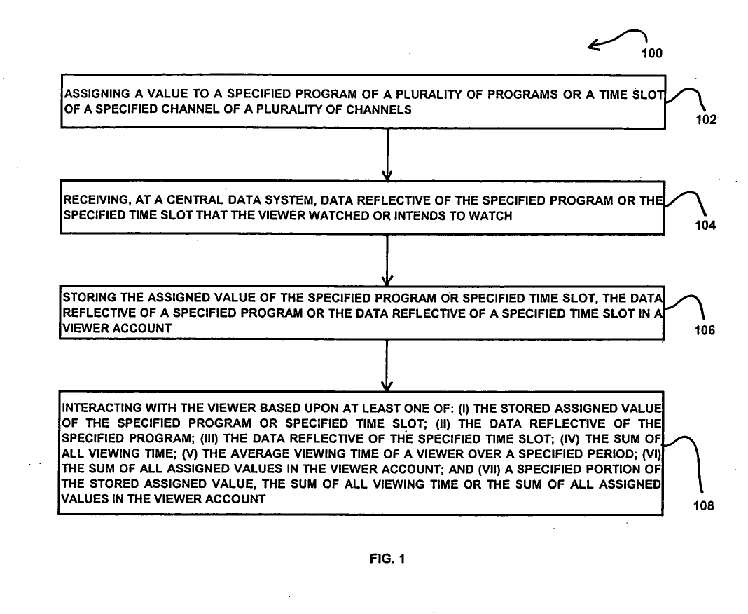

The present invention is directed to a method 100 for rewarding a television viewer and a system 10 for implementing such a method. In general, the present invention provides a method 100 and system 10 that engenders loyalty between a viewer 12 and a television 14 station or channel that the viewer 12 watches or intends to watch. The various preferred and non-limiting embodiments of the presently-invented method 100 and system 10 are illustrated in FIGS. 1-3.

In one embodiment, the method 100 according to the present invention is a method 100 for rewarding a television viewer 12 that views at least one program over a channel of a television 14. The method includes the steps of: assigning a value 16 to a specified program of a plurality of programs or a time slot of a specified channel of a plurality of channels (Step 102); receiving, at a central data system 18, data 20 reflective of the specified program or the specified time slot that the viewer 12 watched or intends to watch (Step 104); storing the assigned value 16 of the specified program or the specified time slot, the data 20 reflective of the specified program or the data 20 reflective of the specified time slot in a viewer account 24 (Step 106); and interacting with a viewer 12 based upon: (i) the stored assigned value 16 of the specified program or specified time slot in the viewer account; (ii) the data 20 reflective of the specified program; (iii) the data 20 reflective of the specified time slot; (iv) the sum of all viewing time; (v) the average viewing time of a viewer 12 over a specified period; (vi) the sum of all stored assigned values 16 in a viewer account 24; and/or (vii) a specified portion of the stored assigned value 16, the sum of all viewing time or the sum of all assigned values in the viewer account 24 (Step 108). See FIG. 1.

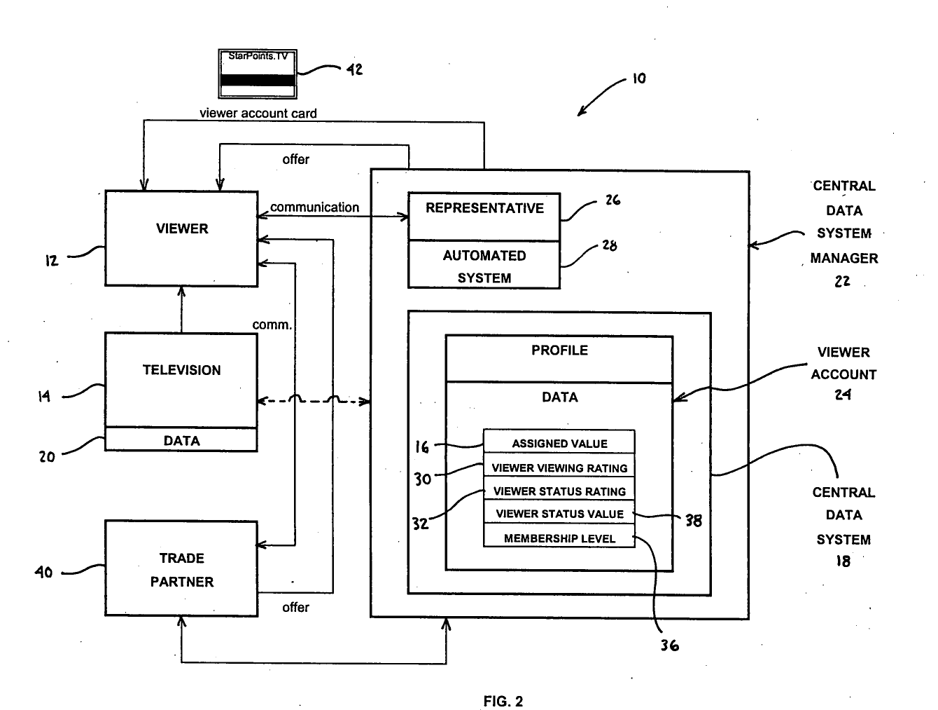

FIG. 2 illustrates one preferred and non-limiting embodiment of the system 10 and how the various entities in this embodiment interact. Further, the system 10 (and method 100) are used in connection with a television viewer 12 who views one, and typically multiple, programs over a channel of a television 14. In the system 10, a value is assigned to a specific program or a specific time slot of a specified channel, thereby providing an assigned value 16 for this specified program or time slot.

At this point, the viewer 12 may begin watching, have watched or may intend to watch a specific program or time slot on the channel on the television 14. Accordingly, a central data system 18 receives data 20 that is reflective of this specified program or specified time slot. Further, this data 20 and/or the assigned value 16 is stored in the central data system 18. Finally, a central data system manager 22 interacts with the viewer 12 based upon the stored assigned value 16 of the specified program or specified time slot, the data 20 reflective of the specified program or specified time slot, the sum of all viewing time, the average viewing time of the viewer 12 over a specified period, the sum of all stored assigned values 16 in a viewer account 24, and/or a specified portion of the stored assigned value 16, the sums, the averages, and the like.

In order to initiate the method 100 in the system 10, there is some communication or a form of contact between the viewer 12 and the central data system manager 22. In particular, and in one preferred and non-limiting embodiment, the viewer 12 communicates with a representative 26 or an automated system 28 of the central data system manager 22. This allows the central data system manager 22 to track the provision of the program or time slot over the channel of the television to the viewer 12. Once the communication is complete between the viewer 12 and the central data system manager 22, the viewer account 24 can be appropriately modified using the supplied data 20. For example, if the viewer 12 indicates that he or she has watched, is watching or intends to watch a specified program to the representative 26 or automated system 28, the central data system manager 22 can then credit the viewer account 24 the appropriate assigned value 16.

It is also envisioned that the viewer 12 can interact directly with the television 14, such as through the use of an interactive remote control, which may be in communication with the central data system manager 22. Accordingly, no direct communication between the viewer 12 and central data system manager 22 would be required. Such an automated system 10 would allow for easier and quicker interaction between the viewer 12 and the central data system manager 22. The communication between the television 14 (or associated control box) and the central data system manager 22 could be hardwired or wireless.

Dependent upon the data 20 and other information in the viewer account 24 in the central data system 18, the central data system manager 22 can make certain offers to a viewer 12. For example, the central data system manager 22 may offer to the viewer 12 a service, an item, a discount, a redemption, a coupon, a voucher, a non-cash benefit, an incentive, a ticket, an invitation, an event, and the like. The type, quality and value of the offer is based upon the information available to the central data system manager 22 regarding the viewer account 24. In particular, the offer can be based upon: the stored assigned value 16 of a specified program or specified time slot in the viewer account 24; the data 20 reflective of the specified program; the data 20 reflective of the specified time slot; the sum of all viewing time; the average viewing time of a viewer 12 over a specified period; the sum of all stored assigned values 16 in the viewer account 24; a stored viewer status value 38; a viewer viewing rating 30; a viewer status rating 32; and/or a specified portion of these values, sums, averages, and the like. In one embodiment, the offer is a coupon or voucher, such as an entry ticket for an event (the cinema, the zoo and the like), which can be downloaded from the Internet. For example, in order to initiate the download, the viewer 12 appropriately identifies himself or herself on a website.

It is envisioned that the viewer 12 can interact with the system 10 after registration with the system 10 or the central data system manager 22. Initial registration may be accomplished via any normal means of communication, such as by telephone, by Internet, by e-mail, by mail, through the television 14, and the like. For example, registration forms may be available at various cooperating entities. Once registered, the viewer account 24 is created in the central data system 18, and the viewer 12 can begin accruing or accumulating values 16 and data 20 in the viewer account 24.

In one preferred and non-limiting embodiment, in order to accrue assigned values 16 in the viewer account 24, the viewer 12 calls a specific telephone number or logs on to a specific website, which has been identified as a viewer contact point. For example, when using the automated system 28, a voice may prompt the viewer 12 to identify himself or herself. Once appropriately identified, the viewer 12 will identify the specified program or specified time slot that the viewer 12 intends to watch, is watching or has watched. Such information may be entered via a voice recognition program, and all such entries will be saved in the viewer account 24 in the central data system 18.

In addition to the accrual of assigned values 16 or compilation of data 20 in the viewer account 24, the viewer 12 may be assigned a viewer viewing rating 30 or a viewer status rating 32. In one embodiment, the viewer viewing rating 30 is dependent upon the frequency of which the viewer 12 engages in the activity of watching television 14. The viewer viewing rating 30 will increase or otherwise change based upon the viewer's 12 increased television 14 viewing habits. Similarly, the viewer 12 may be assigned the viewer status rating 32 indicative of the viewer's 12 status within the system 10 or program. An increased or elevated viewer status rating 32 will indicate to the system 10 that the viewer 12 deserves additional or upgraded offers, as discussed above. The viewer viewing rating 30 or the viewer status rating 32 may be based upon any of the values, averages and sums discussed above. However, the viewer viewing rating 30 is typically based upon either the sum of all viewing time or the average viewing time of a viewer over a specified period, while the viewer status rating is typically dependent upon the sum of all stored assigned values 16 or other viewer status value 38 in the viewer account 24.

One benefit of the method 100 and system 10 of the present invention is the flow of data and information between the viewer 12 and the central data system manager 22. Accordingly, additional personal data may be collected in the central data system 18 (and specifically in the viewer account 24) by the central data system manager 22. Based upon such data, a viewer profile 34 can be established in a central data system 18, and this profile 34 is associated with the viewer account 24. Such collected data may take many forms. For example, the data collected may be last name, first name, address, telephone number, e-mail address, gender, age, occupation, television program preference, hobby, interests, salary, available income, household data, credit card data, purchase data, purchase location, purchased item data, purchased service data, sales volume, transaction data and personal data. Some or all of this information can be used in establishing the user's or a viewer's 12 profile 34. Furthermore, using this data and the profile 34, the central data system manager 22 can provide improved and targeted offers to the viewer 12 in the system 10.

In order to facilitate appropriate and secure communication between the viewer 12 and the representative 26 and/or automated system 28, the viewer 12 may be assigned a viewer identification and/or a viewer password. The viewer identification and viewer password can be provided to the viewer 12, and then used in all future communications between the viewer 12 and the central data system manager 22. For example, the viewer identification and viewer password can be used when the viewer 12 is interacting with the system 10 and identifying the specified program or time slot that the viewer 12 is watching, has watched or intends to watch. In addition, the viewer identification and viewer password can be used on an affiliated website associated with the system 10.

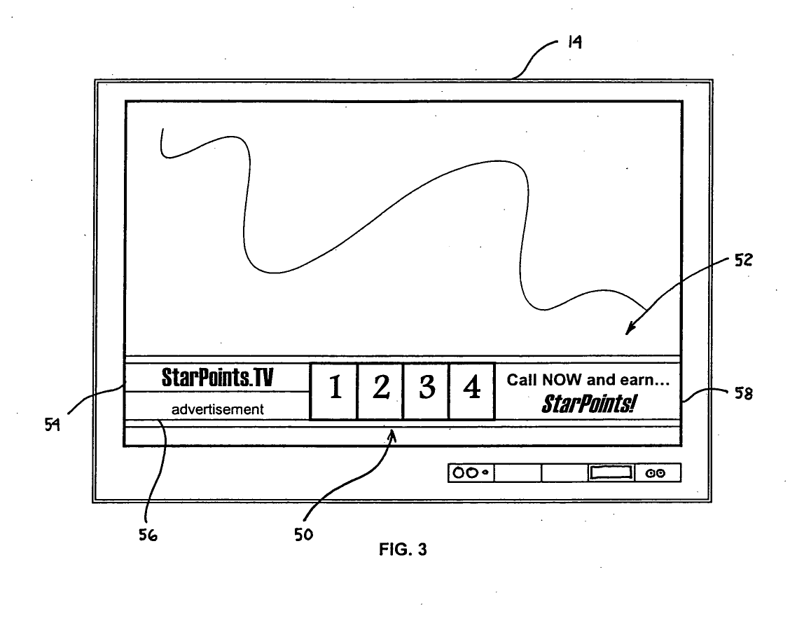

In one preferred and non-limiting embodiment of the present invention, a specified program or specified time slot is assigned a specified program or specified time slot identification 50. It is this identification 50 that is provided over the television 14 to the viewer 12, such that the viewer 12 can interact with the central data system manager 22 regarding his or her viewing habits. This identification 50 can be a number, a letter, a numeric value, an alphanumeric value, or the like. As seen in FIG. 3, the identification 50 is presented in a banner 52, which extends across the bottom portion of the screen of the television 14. In this example, the banner 52 includes a logo portion 54, which identifies the central data system manager 22. In addition, the banner 52 may include an advertisement portion 56, as well as a message portion 58. The advertisement portion 56 provides the central data system manager 22 with advertising possibilities, as well as advertising possibilities for any affiliated trade partners or related entities. Further, the message portion 58 provides an area where the central data system manager 22 can provide messages to the viewer 12, such as an indication that the viewer 12 should communicate with the central data system manager 22, indicate the identification 50 and earn or accrue assigned value 16 in the viewer account 24.

Returning to FIG. 2, and as discussed above, the viewer 12 may be assigned a viewer viewing rating 30. In one embodiment, and based upon this viewer viewing rating 30, the viewer 12 is only permitted to accrue a certain amount of assigned values 16 in the viewer account 24. Therefore, the more often the viewer 12 views a specified program, time slot or channel, the resulting increased viewer viewing rating 30 allows for more value 16 to be accumulated in the viewer account 24, which translates into increased and better offers.

It is also envisioned that the viewer 12 can be assigned to a specific membership level 36. For example, at initial registration, the viewer 12 would be assigned the lowest membership level 36, but based upon the viewer 12 data, the information or data in the viewer account 24, the viewer viewing habits or other interactions, the membership level 36 can increase, allowing the viewer 12 to accumulate additional value and receive increased offers. The membership level 36 may be associated with a number, a color, a symbol, an alphanumeric symbol, a label, a word, a term, or the like.

In one preferred and non-limiting embodiment of the present invention, a viewer status value 38 can be accrued in the viewer account 24. The viewer status value 38 in the viewer account 24 may be based upon the viewer's 12 interaction in other non-television media. The viewer status value 38 can be accrued, and there is additional interaction between the viewer 12 and the central data system manager 22 based upon the accrued value. For example, the non-television media may be a video, a box office movie, a newspaper, a magazine, a book, a document, a website, or the like.

In one embodiment, based upon the accrued viewer status value 38 in the viewer account 24 an affiliated trade partner 40 may make additional, subsequent or supplementary offers to the viewer 12. The affiliated trade partner 40 would be associated with and in communication with the central data system manager 22. As with the central data system manager 22, the affiliated trade partner 40 could offer the viewer 12 a service, an item, a discount, a redemption, a coupon, a voucher, a non-cash benefit, an incentive, a ticket, an invitation, an even or other rewards or benefits. The trade partner 40 may be a merchant, a company, a website, a seller, a reseller, or other entity affiliated with the central data system manager 22.

In a further embodiment, the accumulated viewer status value 38 can be used for moving or elevating to a higher viewer status rating 32 or membership level 36. Accordingly, the viewer status value 38 would not be used directly for any redemption, discount, coupon, and the like. However, in yet another embodiment, the accumulated viewer status value 38 would be redeemable as discussed above in connection with the assigned value 16. For example, the accumulated assigned value 16 and the viewer status value 38 could be used in making various offers by the central data system manager 22 to the viewer 12.

In another embodiment, the viewer 12 is provided with a viewer account card 42 associated with the viewer account 24. It is envisioned that the viewer 12 can use this card 42 in connection with interactions with the central data system manager 22 and/or any of the affiliated trade partners 40. In addition, the card 42 can be associated with a certain membership level 36, viewer viewing rating 30, and/or viewer status rating 32. For example, the cards 42 can be associated with a membership level 36, which are blue, silver and gold. The blue card 42 would be issued directly following registration. All other cards 42 will be issued to viewer 12 after the relevant higher level 36 has been reached. The viewer status rating 32, membership level 36 and/or card 42 level can be associated with various aspects of the viewer's 12 profile. For example, special cards may be available or offered for persons over a certain age, for example over 50 years, and rechargeable cards 42 can be offered for children. Various targeted viewer status ratings 32 and membership levels 36 are envisioned for providing specific benefits to various classes of viewers 12.

With respect to card validity, these cards 42 may only be valid according to the relevant level of viewed programs for one year after issuance. For example, a blue level card 42 may be issued in the year 2005, but if the viewer 12 does not reach the next level, then the blue card 42 will be maintained in 2006 as well. Accordingly, no new card 42 will be issued. If the viewer 12 cannot validate his or her level in 2006, the card 42 will automatically expire after twelve months. If the viewer 12 reaches the next level in 2006, then he or she will automatically receive the silver or gold card, which he or she has to validate until 2007. Similarly, if he or she cannot validate this level in 2007, then the card 42 will, in turn, expire after twelve months. The viewer 12 will then receive the card 42 which relates to the current accrued value 16 in the viewer account 24.

In creating the profile 34 for the viewer account 24 in the central data system 18, and as discussed above, different user data can be obtained. In addition, when a viewer 12 is interacting with an affiliated trade partner 40, such as a vendor or merchant, additional purchase transaction data can be gathered at the point of sale. This information, in turn, can be used to accrue viewer status value 38 in the viewer account 24.

### EXAMPLE

In one example of the presently-invented method 100 and system 10, and in operation, a central data system manager 22 logo, identification 50 (in the form of a four digit number) and a message portion 58 (in the form of a request to “call now”) are displayed on the television 14 screen for 15 seconds on the upper or lower screen margin. The telephone number of the central data system manager 22 is provided either on the screen or on the card 42 provided to the viewer 12.

The viewer then contacts the representative 26 or automated system 28, such as by telephone, e-mail, Internet, SMS, an interactive remote control and the like, and states the correct numerical sequence or identification 50. The viewer 12 has a 15-minute time limit open to make this communication, and all of the digits of the identification 50 must be correct to be awarded the assigned value 16 of the program or time slot. In general, the viewer 12 collects points (in the form of an accrued assigned value 16) in the viewer account 24. The programs or time slots for which the viewer 12 can collect points (assigned values 16) should be spread throughout the daily television 14 schedule. This assists the central data system manager 22 in gathering more precise and representative data 20 regarding viewing habits. One example of such a schedule is as follows:

| | | |
|---|---|---|
| Night Time | 11:00 p.m.-6:00 a.m. | one show with assigned value 16 |
| Morning | 6:00 a.m.-12:00 p.m. | one show with assigned value 16 |
| Time | | |
| Day Time | 12:00 p.m.-5:00 p.m. | one show with assigned value 16 |
| Access Time | 5:00 p.m.-8:00 p.m. | one show with assigned value 16 |
| Prime Time | 8:00 p.m.-11:00 p.m. | two shows with assigned value 16 |

In order to reward the viewer 12 for more frequent viewing of the a specified channel, in this example, the viewer viewing rating 30 is used to determined how many assigned values 16 or how much accrued assigned value 16 can be obtained by the viewer 12 on a daily basis. One example of such a viewer viewing rating 30 system is as follows:

Each program or time slot has an assigned value of 10 points.

Frequent Viewer views television for at least 400 minutes per day:

Can collect an assigned value 16 a maximum of 6 times per day=60 points.

Average Viewer views television for at least 200 minutes per day:

Can collect an assigned value 16 a maximum of 3 times per day=30 points.

Occasional Viewer views television for at least 100 minutes per day:

Can collect an assigned value 16 a maximum of 1 time per day=10 points.

In order to upgrade a viewer's 12 viewer status rating 32 or membership level 36, in this example, the viewer 12 collects viewer status values 38 for certain activities. These viewer status values 38 are “status” points, which cannot be directly redeemed, but instead are credited towards a higher viewer status rating 32 or membership level 36. One example of an activity that awards the viewer 12 with viewer status values 38 is purchases made at an affiliated trade partner 40. For each monetary increment spent at the trade partner 40, the viewer 12 receives a status point or a viewer status value 38. In this example, if the viewer 12 would make all of his or her purchases at one of the affiliated trade partner 40, the viewer 12 could accrue up to 10,000 status points.

In this example, the following model is arrived at: a maximum of 21,900 points can be earned watching television 14; a maximum of 10,000 points can be earned from the affiliated trade partners 40; and a grand total of 31,900 points can be earned. The following viewer status ratings 32 or membership levels 36 can be used:

| | |
|---|---|
| Blue | 1,500 points per year |
| Silver | 3,000 points per year |
| Gold | 6,000 points per year |

In addition, viewer status values 38 can be collected by reading daily newspapers. In this example, the four-digit code will be printed in the newspaper, and the viewer 12 will communicate with the central data system manager 22. Based upon the viewer's 12 accrued assigned values 16 in the viewer account 24, the central data system manager 22 may offer the viewer 12 special opportunities and activities, such as invitations to television shows, trips to events (such as film openings or award ceremonies), special merchandising and product give-aways, and other specific television- and lifestyle-related product discounts.

The viewer 12 can receive non-cash benefits or incentives from the affiliated trade partners 40, which may match the viewer status rating 32 or membership level 36. In a transaction with a trade partner 40, the viewer 12 may simply display his or her card 42. The card 42 is read into the trade partner 40 system, and the viewer 12 receives the appropriate points, values, benefits, incentives or awards matching the accumulated levels. The card 42 may be a combination card with a barcode, digit code and magnetic strip. The card 42 can then be used by all trade partners 40 with existing hardware.

In this manner, the present invention provides a method 100 and system 10 that creates a viewer 12 loyalty program, which rewards viewers 12 for watching a specific channel of television 14. This method 100 and system 10 is advantageous to the viewer 12, the central data system manager 22, the television station and the trade partners 40. The viewer 12 receives rewards for watching television, such as items, services, discounts and redemptions. The television station receives increased income, increased market share, increased viewer 12 loyalty and more accurate data regarding their viewing public. The trade partners receive increased income, increased marketing ability, increased loyalty and better advertising. In all, the presently-invented method 100 and system 10 provides a mutual beneficial and loyal relationship between the participating parties.

This invention has been described with reference to the preferred embodiments. Obvious modifications and alterations will occur to others upon reading and understanding the preceding detailed description. It is intended that the invention be construed as including all such modifications and alterations.

The invention claimed is:

1. A method for rewarding a television viewer who views at least one program over a channel of a television, the method comprising the steps of:
assigning a value to a specified program of a plurality of programs or a time slot of a specified channel of a plurality of channels;
receiving, at a central data system, data reflective of the specified program or the specified time slot that the viewer watched or intends to watch;
storing the assigned value of the specified program or the specified time slot, the data reflective of the specified program or the data reflective of the specified time slot in a viewer account; and
interacting with the viewer based upon at least one of:
(i) the stored assigned value of the specified program or specified time slot in the viewer account;
(ii) the data reflective of the specified program;
(iii) the data reflective of the specified time slot;
(iv) the sum of all viewing time;
(v) the average viewing time of a viewer over a specified period;
(vi) the sum of all stored assigned values in the viewer account; and
(vii) a specified portion of the stored assigned value, the sum of all viewing time or the sum of all assigned values in the viewer account.

2. The method of claim 1, wherein the receiving step comprises a communication between the viewer and at least one of a representative and an automated system of a central data system manager that tracks the provision of the at least one program over a channel of a television to the viewer.

3. The method of claim 1, further comprising the step of offering, to the viewer by a central data system manager, at least one of a service, an item, a discount, a redemption, a coupon, a voucher, a non-cash benefit, an incentive, a ticket, an invitation and an event, based upon at least one of (i) the stored assigned value of the specified program or specified time slot in the viewer account; (ii) the data reflective of the specified program; (iii) the data reflective of the specified time slot; (iv) the sum of all viewing time; (v) the average viewing time of a viewer over a specified period; (vi) the sum of all stored assigned values in the viewer account; (vii) a stored viewer status value; (viii) a viewer viewing rating; (ix) a viewer status rating; and (x) the specified portion of the stored assigned value, the sum of all viewing time or the sum of all assigned values in the viewer account.

4. The method of claim 1, further comprising the step of creating a viewer account in the central data system for at least one viewer.

5. The method of claim 4, further comprising the step of assigning at least one of a viewer viewing rating and a viewer status rating to the viewer account based upon at least one of (i) the stored assigned value of the specified program or specified time slot in the viewer account; (ii) the data reflective of the specified program; (iii) the data reflective of the specified time slot; (iv) the sum of all viewing time; (v) the average viewing time of a viewer over a specified period; (vi) the sum of all stored assigned values in the viewer account; (vii) a stored viewer status value; and (viii) a specified portion of the stored assigned value, the stored viewer status value, the sum of all viewing time or the sum of all assigned values in the viewer account.

6. The method of claim 1, further comprising the steps of:
collecting data regarding the viewer in central data system;
establishing a viewer profile in the central data system based upon the collected data; and
associating the viewer profile with the viewer account.

7. The method of claim 6, wherein the collected data is at least one of last name, first name, address, telephone number, e-mail address, gender, age, occupation, television program preference, hobby, interest, salary, available income, household data, credit card data, purchase data, purchase location, purchased item data, purchased service data, sales volume, transaction data and personal data.

8. The method of claim 1, further comprising the steps of:
assigning at least one of a viewer identification and a viewer password to a specified viewer;
providing the specified viewer with at least one of the viewer identification and the viewer password; and
communicating, by the viewer to a central data system manager, at least one of the viewer identification and the viewer password.

9. The method of claim 1, further comprising the steps of:
assigning a specified program or specified time slot identification; and
providing the specified program or specified time slot identification to the viewer via the television.

10. The method of claim 1, wherein the assigned value is at least one of a time value, a point value, a numeric value and an alphanumeric value.

11. The method of claim 1, further comprising the step of assigning a viewer viewing rating based upon at least one of (i) the stored assigned value of the specified program or specified time slot in the viewer account; (ii) the data reflective of the specified program; (iii) the data reflective of the specified time slot; (iv) the sum of all viewing time; (v) the average viewing time of a viewer over a specified period; (vi) the sum of all stored assigned values in the viewer account; and (vii) the specified portion of the stored assigned value, the sum of all viewing time or the sum of all assigned values in the viewer account.

12. The method of claim 11, further comprising the steps of:
accruing the stored assigned value of the specified program or the specified time slot in the viewer account; and
limiting the accruable value based upon the viewer rating.

13. The method of claim 11, further comprising the steps of:
assigning a viewer status rating based upon a viewer status value; and
interacting with the viewer based upon the viewer status rating.

14. The method of claim 13, wherein the viewer status value is at least one of a point value, a numeric value and an alphanumeric value.

15. The method of claim 11, further comprising the step of assigning a membership level based upon at least one of (i) the stored assigned value of the specified program or specified time slot in the viewer account; (ii) the data reflective of the specified program; (iii) the data reflective of the specified time slot; (iv) the sum of all viewing time; (v) the average viewing time of a viewer over a specified period; (vi) the sum of all stored assigned values in the viewer account; (vii) a stored viewer status value; (viii) the viewer viewing rating; (ix) a viewer status rating; (x) the specified portion of the stored assigned value, the sum of all viewing time or the sum of all assigned values in the viewer account; and (xi) a portion of viewer data.

16. The method of claim 15, wherein the membership level is associated with at least one of a number, a color, a symbol, an alphanumeric symbol, a label, a word and a term.

17. The method of claim 1, further comprising the steps of:
storing at least one of an assigned value and a viewer status value in the viewer account based upon the viewer's interaction in other non-television media;
accruing the assigned value or viewer status value in the viewer account; and
interacting with the viewer based upon the accrued value.

18. The method of claim 17, wherein the non-television media is at least one of a video, a box office movie, a newspaper, a magazine, a book, a document and a web site.

19. The method of claim 1, further comprising the step of offering, to the viewer by an affiliated trade partner, at least one of a service, an item, a discount, a redemption, a coupon, a voucher, a non-cash benefit, an incentive, a ticket, an invitation and an event, based upon at least one of (i) the stored assigned value of the specified program or specified time slot in the viewer account; (ii) the data reflective of the specified program; (iii) the data reflective of the specified time slot; (iv) the sum of all viewing time; (v) the average viewing time of a viewer over a specified period; (vi) the sum of all stored assigned values in the viewer account; (vii) a stored viewer status value; (viii) a viewer viewing rating; (ix) a viewer status rating; and (x) the specified portion of the stored assigned value, the sum of all viewing time or the sum of all assigned values in the viewer account.

20. The method of claim 19, wherein the affiliated trade partner is at least one of a merchant, a company, a web site, a seller, a reseller and an entity affiliated with the central data system manager.

21. The method of claim 1, further comprising the step of providing a viewer account card to the viewer, wherein the card is associated with the viewer account of the viewer.

22. A system for rewarding a television viewer who views at least one program over a channel of a television, the system comprising:
means for assigning a value to a specified program of a plurality of programs or a time slot of a specified channel of a plurality of channels;
means for receiving, at a central data system, data reflective of the specified program or the specified time slot that the viewer watched or intends to watch;
means for storing the assigned value of the specified program or the specified time slot, the data reflective of the specified program or the data reflective of the specified time slot in a viewer account; and
means for interacting with the viewer based upon at least one of:
(i) the stored assigned value of the specified program or specified time slot in the viewer account;
(ii) the data reflective of the specified program;
(iii) the data reflective of the specified time slot;
(iv) the sum of all viewing time;
(v) the average viewing time of a viewer over a specified period;
(vi) the sum of all stored assigned values in the viewer account; and
(vii) a specified portion of the stored assigned value, the sum of all viewing time or the sum of all assigned values in the viewer account.
